(19) United States
(12) Patent Application Publication
(10) Pub. No.: US 2026/0258649 A1
(43) Pub. Date: Sep. 3, 2026

(54) DRAINAGE NETWORK SEDIMENTATION MANAGEMENT METHODS, SYSTEMS, AND MEDIUM BASED ON LARGE INTERNET OF THINGS MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guobin LUO, Chengdu (CN)

(73) Assignee: CHENGDU QINCHUAN IOT TECHNOLOGY CO., LTD., Chengdu (CN)

(21) Appl. No.: 19/658,784

(22) Filed: Apr. 27, 2026

(30) Foreign Application Priority Data
Mar. 30, 2026 (CN) 202610398921.0

(51) Int. Cl. E03F 7/12; G05B 15/02; G16Y 20/10

(52) U.S. Cl. CPC E03F 7/12; G05B 15/02; G16Y 20/10

(57) ABSTRACT

A drainage network sedimentation management method based on a large Internet of Things (IoT) model is provided. The method includes: acquiring flow data of a pipe section; determining a flow cross-sectional area series of a plurality of adjacent pipe sections based on the flow data of the pipe section; determining a target detection area and a target detection time based on the flow cross-sectional area series of the plurality of adjacent pipe sections; controlling a robot to perform sonar detection on the target detection area at the target detection time, and acquiring sonar detection data; determining a sedimentation risk based on the sonar detection data and pipe characteristics; automatically generating a desilting path and desilting parameters based on the sedimentation risk; controlling automated desilting equipment to travel along the desilting path to a desilting operation point, and performing a desilting operation based on the desilting parameters.

### CROSS-REFERENCE TO RELATED APPLICATIONS

This application claims priority to Chinese Patent Application No. 202610398921.0, filed on Mar. 30, 2026, the entire contents of which are hereby incorporated by reference.

### TECHNICAL FIELD

The present disclosure generally relates to a field of pipeline maintenance, and in particular to a drainage network sedimentation management method, system, and medium based on a large Internet of Things (IoT) model.

### BACKGROUND

An urban drainage network is a key infrastructure that ensures normal operation of a city, and the urban drainage network relates to flood control and drainage capacity and environmental safety of the city. Evaluation of sedimentation status of an existing drainage network mainly relies on traditional detection manners such as manual inspection, closed-circuit television of pipes, or pipe endoscopes. The traditional detection manners can only provide qualitative, two-dimensional image information, and the traditional detection manners cannot perform non-destructive, quantitative evaluation on a thickness and a volume of sedimentation.

Therefore, drainage network sedimentation management method, system, medium based on a large Internet of Things (IoT) model are required to achieve accurate quantitative evaluation of a sedimentation situation, intelligent and efficient desilting operations, and intelligent management and monitoring of the drainage network.

### SUMMARY

One or more embodiments of the present disclosure provide a drainage network sedimentation management system based on a large Internet of Things (IoT) model. The system includes an emergency supervision management platform and an emergency supervision object platform. The emergency supervision management platform is configured to execute a drainage network sedimentation management method based on the large Internet of Things (IoT) model.

One or more embodiments of the present disclosure provide a drainage network sedimentation management method based on a large Internet of Things (IoT) model. The method includes: acquiring flow data of a pipe section by an acquisition device deployed in a drainage network, and obtaining the flow data uploaded by the acquisition device; determining a flow cross-sectional area series of a plurality of adjacent pipe sections based on the flow data of the pipe section; determining an anomalous pipe section and an anomalous flow passage moment based on the flow cross-sectional area series of the plurality of adjacent pipe sections; determining a target detection area and a target detection time based on the anomalous pipe section and the anomalous flow passage moment; controlling, by an emergency supervision object platform, a robot to perform sonar detection on the target detection area at the target detection time, and acquiring sonar detection data, wherein the robot is equipped with a sonar sensor; generating an estimated sedimentation thickness and a sedimentation type of the target detection area based on the sonar detection data and pipe characteristics; determining a sedimentation risk based on the estimated sedimentation thickness, the sedimentation type, and the pipe characteristics; automatically generating a desilting path and desilting parameters based on the sedimentation risk; controlling, by the emergency supervision object platform, automated desilting equipment to travel along the desilting path to a desilting operation point, and performing a desilting operation based on the desilting parameters.

One or more embodiments of the present disclosure provide a computer-readable storage medium. The storage medium stores computer instructions, and when a computer reads the computer instructions in the storage medium, the computer executes a drainage network sedimentation management method based on a large Internet of Things (IoT) model.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering indicates the same structure, wherein:

FIG. 1 is a schematic diagram of a platform structure of a drainage network sedimentation management system based on a large Internet of Things (IoT) model according to some embodiments of the present disclosure;

FIG. 2 is a flowchart of an exemplary process for a drainage network sedimentation management method according to some embodiments of the present disclosure;

FIG. 3 is a schematic diagram of an exemplary process for determining a target detection area according to some embodiments of the present disclosure;

FIG. 4 is a schematic diagram of an exemplary sedimentation model according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

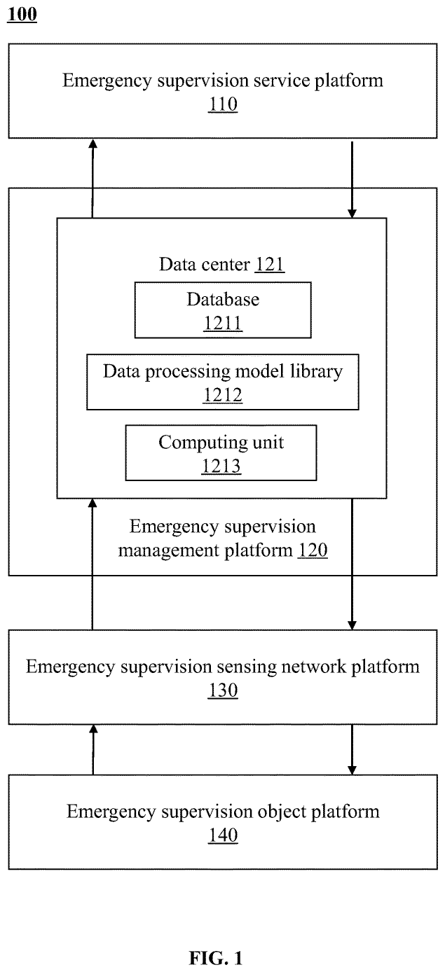

FIG. 1 is a schematic diagram of a platform structure of a drainage network sedimentation management system based on a large Internet of Things (IoT) model according to some embodiments of the present disclosure.

In some embodiments, as shown in FIG. 1, a drainage network sedimentation management system 100 (hereinafter referred to as a system 100) based on a large IoT model may include an emergency supervision service platform 110, an emergency supervision management platform 120, an emergency supervision sensing network platform 130, and an emergency supervision object platform 140. In some embodiments, the emergency supervision service platform 110, the emergency supervision management platform 120, the emergency supervision sensing network platform 130, and the emergency supervision object platform 140 may be interconnected sequentially. The large Internet of Things (IoT) model refers to an IoT model architecture, which is used to achieve efficient operation of a large amount of data in the system 100. In some embodiments, an artificial intelligence (AI) model (e.g., ChatGPT, Gemini, DeepSeek) may be applied in the IoT model architecture for sensing and processing of data.

The emergency supervision service platform 110 refers to a platform for providing emergency supervision services. For example, the emergency supervision service platform 110 may provide intelligent supervision services for urban drainage network sedimentation management. In some embodiments, the emergency supervision service platform 110 is configured as a server and/or a processor, or the like. The emergency supervision service platform 110 may bidirectionally interact with a data center 121 of the emergency supervision management platform 120. In some embodiments, the emergency supervision management platform 120 may acquire external environment data (e.g., precipitation data released by a meteorological department, surrounding construction data released by an urban planning department, or the like) from the emergency supervision service platform 110, and store the external environment data in a database 1211.

The emergency supervision management platform 120 refers to a comprehensive management platform that coordinates and manages connections and cooperation among a plurality of platforms. In some embodiments, the emergency supervision management platform 120 may be a platform for supervising and managing relevant information about urban drainage network sedimentation. In some embodiments, the emergency supervision management platform 120 may include a server, a processor, a data storage system, a large screen display system, IoT platform software, and communication components (e.g., a communication interface, a gateway, or the like). In some embodiments, an emergency supervision management platform 120 may be a software platform running on a server or in a cloud, for processing data and/or information acquired from other platforms (e.g., the emergency supervision service platform 110, the emergency supervision sensing network platform 130). The emergency supervision management platform 120 may execute program instructions based on the acquired data, information, and/or corresponding processing results, to perform the functions and/or operations described in the present disclosure.

In some embodiments, the emergency supervision management platform 120 may include the data center 121. The data center 121 may include the database 1211, a data processing model library 1212, and a computing unit 1213.

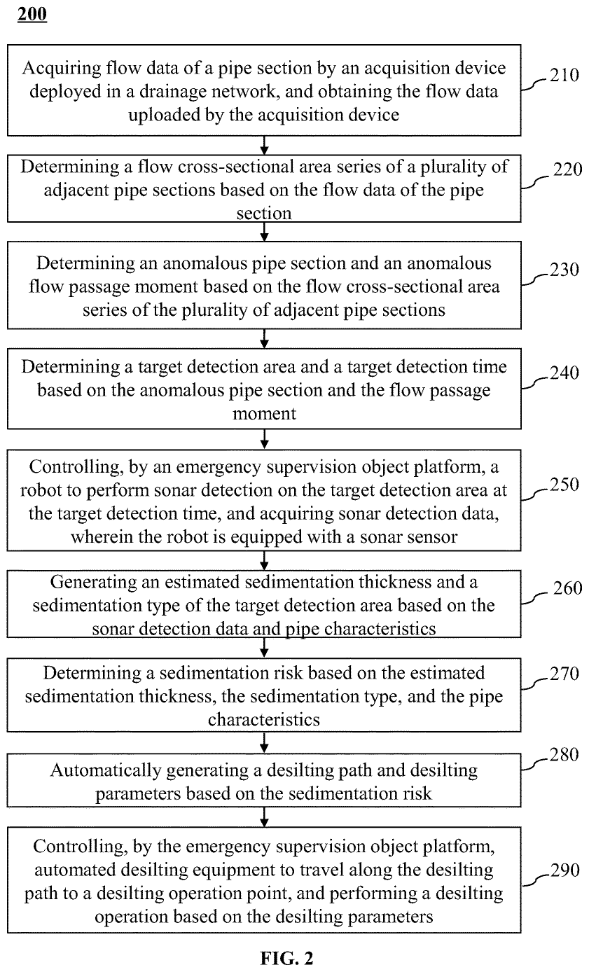

The database 1211 is configured to collect, store, and manage relevant data related to drainage network sedimentation, such as flow data of a pipe section, sonar detection data, pipe characteristics, drainage network information, or the like. The database 1211 may include a relational database (such as MySQL, PostgreSQL) and a time-series database (such as InfluxDB), or the like. In some embodiments, the database 1211 may include a Geographic Information System (GIS) database of the drainage network, a sedimentation database, a first preset table, a second preset table, or the like. More descriptions regarding the flow data of the pipe section, the sonar detection data, the pipe characteristics, the drainage network information, the sedimentation database, the first preset table, and the second preset table may be found in FIG. 2 and related descriptions thereof.

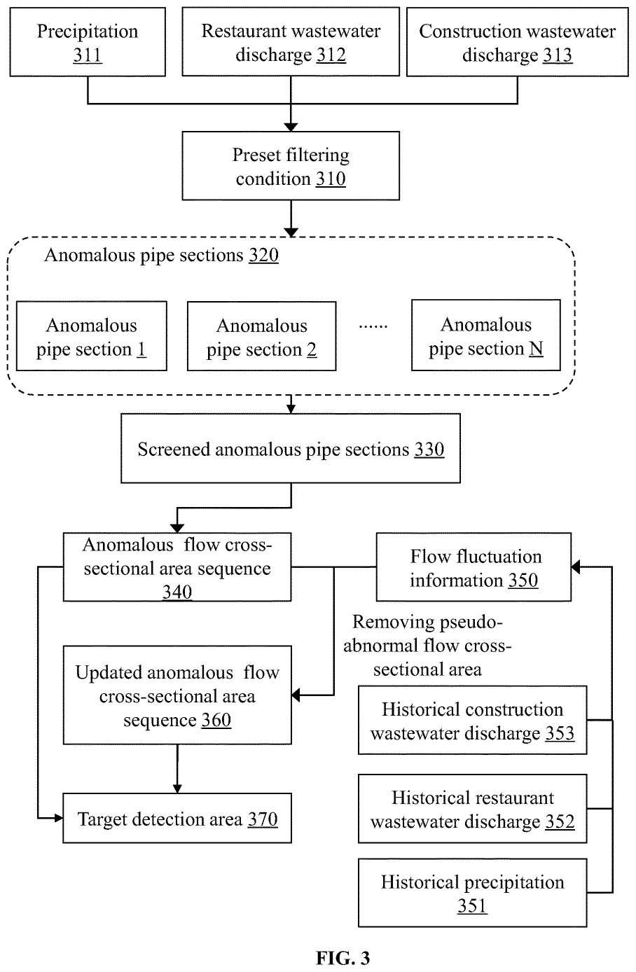

The data processing model library 1212 is configured to store trained large data processing models. In some embodiments, the data processing model library 1212 may include a sedimentation model, an image processing model, a chatbot, or the like. More descriptions regarding the image processing model and the sedimentation model may be found in FIGS. 2-3 and related descriptions thereof.

The computing unit 1213 refers to a functional module that performs arithmetic, logical, and other instruction operations. The computing unit 1213 may include a processor, such as a Central Processing Unit (CPU), a Graphics Processing Unit (GPU), a Field-Programmable Gate Array (FPGA), an Application Specific Integrated Circuit (ASIC), an Application Specific Instruction Set Processor (ASIP), or the like.

The emergency supervision sensing network platform 130 refers to a platform configured to comprehensively manage sensing information. In some embodiments, the emergency supervision sensing network platform 130 may be configured as a communication network and/or an IoT gateway, or the like. The emergency supervision sensing network platform 130 may bidirectionally interact with the data center 121 and the emergency supervision object platform 140. In some embodiments, the emergency supervision sensing network platform 130 may acquire and store uploaded real-time data (e.g., water pressure, wastewater discharge, internal pipe images, or the like) from sensors and acquisition devices (e.g., a pressure water level gauge, a flow meter, an image acquisition device) deployed in the drainage network. The emergency supervision sensing network platform 130 may transmit the received real-time data to the emergency supervision management platform 120. The emergency supervision management platform 120 may store the received real-time data in the database 1211.

The emergency supervision object platform 140 refers to a platform for supervised physical entities or systems. The emergency supervision object platform 140 may be used to display, manage, and analyze the operational status and data of the supervised physical entities or systems. In some embodiments, the emergency supervision object platform 140 may include a processor, an embedded controller, a server, a gateway, or the like. In some embodiments, the supervised physical entities may be deployed at a desilting operation site. In some embodiments, the emergency supervision object platform 140 may be used to manage and control robots and automated desilting equipment. For example, the emergency supervision object platform 140 may establish a communication connection with the robot and the automated desilting equipment to achieve bidirectional interaction of data and instructions. The emergency supervision object platform 140 may receive instructions from the emergency supervision management platform 120 through the emergency supervision sensing network platform 130, to control the robot to perform sonar detection, and to control the automated desilting equipment to perform a desilting operation.

The robot refers to specialized robotic equipment that performs cleaning of sludge, garbage, and sediment through automation and intelligent technologies. For example, the robot may include a jet-type pipe desilting robot, an intelligent pipe desilting robot, an all-terrain pipe desilting robot, or the like. In some embodiments, the robot may be equipped with a sonar sensor. The sonar sensor refers to an electronic device that utilizes sound waves for detection, localization, navigation, and imaging.

The automated desilting equipment refers to equipment that achieves automatic detection, cleaning, transportation, or treatment of internal pipe sediments through machinery, hydraulics, electrical control, sensors, artificial intelligence, or the like. For example, the automated desilting equipment may include high-pressure water flow equipment, vacuum suction equipment, winch equipment, or the like.

In embodiments of the present disclosure, the system 100 is capable of automatically and intelligently achieving sedimentation management of urban drainage networks. Through real-time monitoring, intelligent analysis, and risk estimation, the system 100 is capable of achieving precise control of the robot and the automated desilting equipment, significantly improving the accuracy of sedimentation assessment and the efficiency of desilting operations, and realizing intelligent closed-loop management from passive response to proactive prevention. Meanwhile, usage of the large IoT model makes the integration, analysis, and decision-making of multi-source data more efficient and comprehensive.

FIG. 2 is a flowchart of an exemplary process for a drainage network sedimentation management method according to some embodiments of the present disclosure. As shown in FIG. 2, the process 200 includes the following operations. In some embodiments, the process 200 may be performed by the emergency supervision management platform 120.

In 210, flow data of a pipe section may be acquired by an acquisition device deployed in a drainage network, and the flow data uploaded by the acquisition device may be obtained.

The drainage network refers to a system composed of pipes, channels, and ancillary facilities (e.g., inspection wells, storm drains, and pump stations). The drainage network may be configured to collect, transport, and discharge sewage, wastewater, and rainwater. In some embodiments, the drainage network may include a combined drainage network and a separated drainage network. The combined drainage network refers to a system that mixes and discharges sewage and rainwater. The separated drainage network refers to a system that independently discharges sewage and rainwater.

The acquisition device refers to a device for acquiring the drainage data. For example, the acquisition device may be a pressure water level gauge. In some embodiments, the drainage data may include flow, a water level, water quality, precipitation, pipe status data, or the like. The pipe status data may include a sedimentation degree, a flow velocity, or the like.

The pipe section refers to a physical space range occupied by the pipes and the ancillary facilities (e.g., the inspection wells, the storm drains, and the pump stations). In some embodiments, a plurality of pipe sections may constitute the drainage network. The pipe section may be preset by the system. In some embodiments, the pipe section may be determined based on the drainage network information. More descriptions regarding the drainage network information may be found in operation 280 and related descriptions thereof.

The flow data refers to data related to fluids in the pipes (e.g., rainwater and sewage). In some embodiments, the flow data may include a fluid pressure, a fluid volume passing through the pipe per unit time (e.g., cubic meters per second), a flow velocity (m/s), or the like.

In some embodiments, the acquisition device may be deployed within pipes of the plurality of pipe sections, and acquire the flow data of the plurality of pipe sections in real time. In some embodiments, the acquisition device may periodically acquire the flow data of the plurality of pipe sections based on a preset acquisition period. The preset acquisition period may be set manually or by the system.

In some embodiments, the acquisition device may monitor a control signal from the emergency supervision management platform 120 based on a preset monitoring period. In response to receiving the control signal, the acquisition device may upload the flow data to the emergency supervision management platform 120. The preset monitoring period may be set manually or by the system.

In 220, a flow cross-sectional area series of a plurality of adjacent pipe sections may be determined based on the flow data of the pipe section.

The adjacent pipe section refers to at least two pipe sections that are directly connected in physical space among the plurality of pipe sections. For example, the adjacent pipe section has a shared connection point. In some embodiments, the shared connection point may be a connection point between pipes. For example, an upstream pipe and a downstream pipe that use the same inspection well as a shared connection point, the upstream pipe and the downstream pipe are respectively located in an upstream pipe section and a downstream pipe section.

The flow cross-sectional area series refers to a numerical sequence composed of at least one flow area. The flow area refers to an area occupied by fluid (e.g., the rainwater and the sewage) in a pipe cross section. In some embodiments, the flow cross-sectional area series may include flow areas respectively corresponding to the plurality of pipe sections at the same time instant or within the same time period. In some embodiments, the flow cross-sectional area series may include a flow area of a pipe section at a plurality of time instants or a flow area of the pipe section within a plurality of time periods.

In some embodiments, the emergency supervision management platform 120 may determine the flow cross-sectional area series of the plurality of adjacent pipe sections based on fluid pressure in the flow data of the pipe section. The emergency supervision management platform 120 may obtain the fluid pressure of the pipe section by a pressure water level gauge deployed within the pipe section; determine a water level height of the pipe section based on the fluid pressure of the pipe section and by formula (1). The emergency supervision management platform 120 may determine the flow area of the pipe section based on the water level height of the pipe section and the pipe data (e.g., a pipe diameter) and by a geometric formula (e.g., a circular segment area formula). The formula (1) may be expressed as:

$$h = P / ρ \times g , \qquad ( 1 )$$

h is the water level height of the pipe section, P is the fluid pressure of the pipe within the pipe section, ρ is density of water, and g is gravitational acceleration.

In some embodiments, the emergency supervision management platform 120 may obtain the pipe data from the database 1211. In some embodiments, the emergency supervision management platform 120 may determine flow areas respectively corresponding to the plurality of adjacent pipe sections at the same time instant or within the same time period as the flow cross-sectional area series. In some embodiments, for a pipe section among the plurality of adjacent pipe sections, the emergency supervision management platform 120 may determine flow areas of the pipe section at a plurality of time instants or flow areas of the pipe section within a plurality of time periods as the flow cross-sectional area series.

In 230, an anomalous pipe section and an anomalous flow passage moment may be determined based on the flow cross-sectional area series of the plurality of adjacent pipe sections.

The anomalous pipe section refers to a pipe section where the flow data is anomalous. For example, the flow data of the anomalous pipe section is lower than preset flow data. Merely by way of example, a preset fluid volume per hour is 1000 m³, and an actual fluid volume per hour of an anomalous pipe section is 500 m³; a preset flow velocity is 1.2 m/s, and an actual flow velocity of the anomalous pipe section is 0.5 m³/h. As another example, the flow area of the anomalous pipe section decreases, resulting in poor drainage.

The anomalous flow passage moment refers to a time instant when the flow data of the pipe section is anomalous. For example, the anomalous flow passage moment may be a time instant when the flow data of the pipe section is lower than the preset flow data. More descriptions regarding the flow data may be found in operation 210 and related descriptions thereof.

In some embodiments, in response to the flow cross-sectional area series being flow areas respectively corresponding to a plurality of adjacent pipe sections at the same time instant t, the emergency supervision management platform 120 may determine an average flow area based on the flow cross-sectional area series. It is known that there are two situations: the flow area of the adjacent pipe section is less than or equal to the average flow area, and the flow area of the adjacent pipe section is greater than the average flow area. In response to the flow area of the adjacent pipe section being significantly smaller than the average flow area (e.g., the flow area is less than 80% of the average flow area), the emergency supervision management platform may determine the adjacent pipe section as an anomalous pipe section, and determine the time instant t as an anomalous flow passage moment.

In some embodiments, it is known that there are two situations: the flow area of the adjacent pipe section is less than or equal to a flow area threshold, and the flow area of the adjacent pipe section is greater than the flow area threshold. For an adjacent pipe section among the plurality of adjacent pipe sections, in response to the flow cross-sectional area series being the flow areas of the adjacent pipe section at a plurality of time instants, that is, the flow cross-sectional area series of the adjacent pipe section is {(t₁, a₁), (t₂, a₂) . . . (tₙ, aₙ)}, if a flow area aᵢ at time instant tᵢ (i≥1) is significantly smaller than the flow area threshold (e.g., less than 80% of the flow area threshold), the emergency supervision management platform may determine the adjacent pipe section as an anomalous pipe section, and determine the time instant ti as an anomalous flow passage moment. The flow area threshold may be set based on experience or by the system.

In 240, a target detection area and a target detection time may be determined based on the anomalous pipe section and the anomalous flow passage moment.

The target detection area refers to a pipe section where the desilting operation needs to be performed. For example, the target detection area may be a pipe section with poor drainage.

The target detection time refers to a time period or a time window for performing the desilting operation. For example, the target detection time may be a time period or a time window starting from the anomalous flow passage moment.

In some embodiments, the emergency supervision management platform may directly determine the anomalous pipe section as the target detection area. In some embodiments, the emergency supervision management platform 120 may screen the anomalous pipe section by a preset filtering condition, and determine the target detection area based on the screened anomalous pipe section. More descriptions may be found in FIG. 3 and related descriptions thereof.

In some embodiments, the emergency supervision management platform 120 may determine a preset time window starting from the anomalous flow passage moment as the target detection time. The preset time window may be set based on experience or by the system.

In 250, an emergency supervision object platform controls a robot to perform sonar detection on the target detection area at the target detection time, and sonar detection data may be acquired.

In some embodiments, the robot is equipped with a sonar sensor.

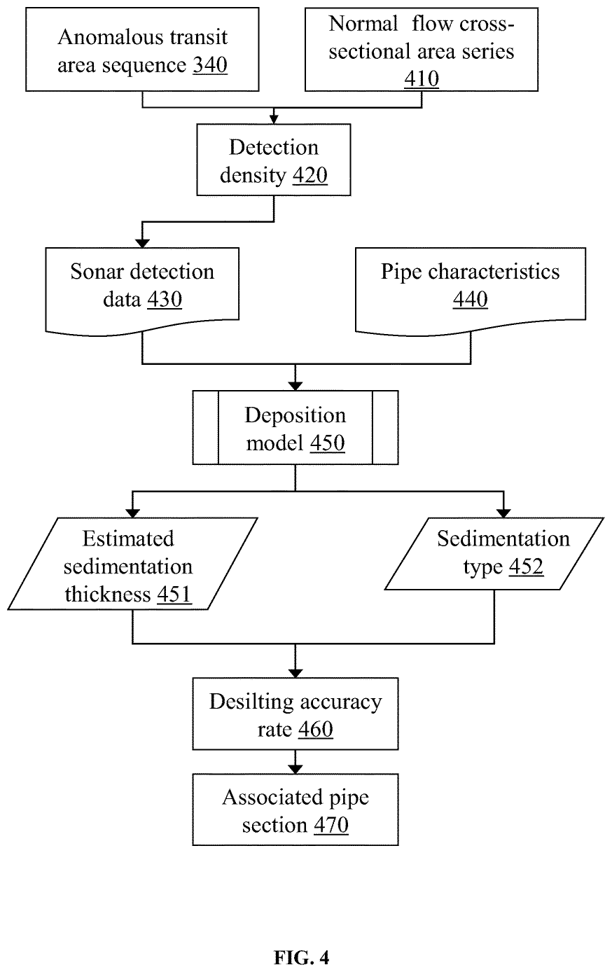

The sonar detection data refers to data generated after the sonar sensor transmits sound waves and receives echoes. For example, the sonar detection data may include a position of the robot, attitude data of the robot (e.g., a pitch angle, a roll angle, a yaw angle), round-trip time of the sound waves, an echo signal strength, an echo waveform, a time when the robot scans the pipe, and a sonar scanning angle. In some embodiments, the sonar detection data may include sonar detection data of circumferential measurement points of the pipe. More descriptions regarding the circumferential measurement points of the pipe may be found in FIG. 4 and related descriptions thereof.

In some embodiments, the emergency supervision management platform 120 may send guidance instructions to the emergency supervision object platform 140 through the emergency supervision sensing network platform 130. The emergency supervision object platform 140 may send guidance instructions to the robot through a wireless network, and controls the robot to perform the sonar detection on the target detection area at the target detection time, and acquire the sonar detection data. More descriptions regarding the robot and the sensor may be found in FIG. 1 and related descriptions thereof.

In 260, an estimated sedimentation thickness and a sedimentation type of the target detection area may be generated based on the sonar detection data and pipe characteristics.

The pipe characteristics are used to characterize physical properties, geographic information, and dimensional parameters of the pipe. In some embodiments, the pipe characteristics may include geometric characteristics (e.g., a pipe diameter, a pipe length, a pipe shape), material characteristics (e.g., concrete), location characteristics (e.g., an inspection well number, latitude and longitude, a burial depth), and network characteristics (e.g., a main pipe, a branch pipe, upstream and downstream pipes). In some embodiments, the pipe characteristics may be determined based on the drainage network information. More descriptions regarding the drainage network information may be found in operation 280 and related descriptions thereof.

The estimated sedimentation thickness refers to an accumulated thickness of sediment (e.g., silt, sludge, debris) in the pipe. For example, the estimated sedimentation thickness is 30% of the pipe diameter (approximately 15 cm).

The sedimentation type refers to a type of pipe sediment. In some embodiments, the sedimentation type may include loose sediment (e.g., silt, sludge), viscous sediment (e.g., grease, fat, saponified matter), hard scaling (e.g., hard shell formed by calcium carbonate, calcium sulfate, etc.), and foreign objects (e.g., stones, construction waste, plant roots).

In some embodiments, the emergency supervision management platform 120 may construct a point cloud of the pipe and sediment based on the sonar detection data and the pipe characteristics of the target detection area, and generate the estimated sedimentation thickness and/or the sedimentation type of the target detection area based on the point cloud of the pipe and sediment.

For example, the emergency supervision management platform 120 may determine distances from a plurality of echo points (i.e., sound wave reflection points on the pipe wall) to the robot based on the round-trip time of the sound waves and a speed of sound. The emergency supervision management platform 120 may convert coordinates of the plurality of echo points in a robot coordinate system into coordinates in a pipe global coordinate system through translation, rotation, scaling, and affine transformation based on attitude data (e.g., the pitch angle, the roll angle, the yaw angle) of the robot. The coordinates of the plurality of echo points in the pipe global coordinate system constitute an initial three-dimensional point cloud. The emergency supervision management platform 120 may adopt a Random Sample Consensus (RANSAC) algorithm to randomly capture a portion of the point cloud in the initial three-dimensional point cloud, and use a cylindrical model to fit the captured portion of the point cloud. The emergency supervision management platform 120 may obtain a point cloud capable of fitting the cylindrical model by iteratively executing the RANSAC algorithm a plurality of times, to generate a pipe point cloud. The point cloud forming a contour of the cylindrical model is a pipe wall point cloud. The point cloud distributed outside the pipe wall point cloud is eliminated, and the point cloud distributed inside the pipe wall point cloud is identified as a sediment point cloud. The emergency supervision management platform 120 may adopt a Density-Based Spatial Clustering of Applications with Noise (DBSCAN) algorithm to extract a point cloud layer on the surface of the sediment. The emergency supervision management platform 120 may determine the estimated sedimentation thickness based on a height of the pipe wall point cloud (e.g., a fitted value of a Z-coordinate value of the pipe wall point cloud) and a height of the point cloud layer on the surface of the sediment (e.g., a fitted value of a Z-coordinate of the point cloud layer on the surface of the sediment).

As another example, the emergency supervision management platform 120 may determine the sedimentation type based on the sonar detection data and/or the sediment point cloud. Merely by way of example, it is known that there are three situations: the echo signal strength is greater than a first intensity threshold; the echo signal strength is greater than or equal to a second intensity threshold and less than or equal to the first intensity threshold; and the echo signal strength is less than the second intensity threshold. In response to the echo signal strength being greater than the first intensity threshold and/or the sediment point cloud having an irregular point cloud contour, the emergency supervision management platform 120 may determine the sedimentation type as hard scaling and foreign objects. In response to the echo signal strength being greater than or equal to the second intensity threshold and less than or equal to the first intensity threshold, the emergency supervision management platform 120 may determine the sedimentation type as loose sediment. In response to the echo signal strength being less than the second intensity threshold, the emergency supervision management platform 120 may determine the sedimentation type as viscous sediment. The first intensity threshold is greater than the second intensity threshold, and the first intensity threshold and the second intensity threshold may be set based on experience or by the system.

In some embodiments, the estimated sedimentation thickness and the sedimentation type of the target detection area may be rendered and displayed in a GIS system.

In some embodiments, the sonar frequencies of the plurality of pipe sections are different. The emergency supervision management platform 120 may determine a sonar frequency of the pipe section based on a pipe material, the estimated sedimentation thickness, and the sedimentation type.

The sonar frequencies may include high-frequency sonar and low-frequency sonar. The high-frequency sonar has a frequency greater than 1 MHz, a short wavelength, and a high resolution, and may be used to describe a surface contour of an object. The low-frequency sonar has the frequency less than 500 kHz, a long wavelength, slow energy attenuation, and strong penetrability, and may be used to detect a bottom of the pipe.

The pipe material refers to a type of material that constitutes a main body of the pipe. For example, the pipe material may include concrete, high-density polyethylene, and cast iron.

In some embodiments, the emergency supervision management platform 120 may determine the sonar frequency of the pipe section based on the pipe material, the estimated sedimentation thickness, and the sedimentation type, through a first preset table.

The first preset table includes a correspondence relationship between the pipe material, the estimated sedimentation thickness, and the sedimentation type, and the sonar frequency. For example, the correspondence relationship may be represented as: {‘Index 1’ (‘the pipe characteristics’), ‘Index 2’ (‘the estimated sedimentation thickness’), ‘Index 3’ (‘the sedimentation type’)->‘Query Result’ (‘the sonar frequency’)}. The first preset table may be constructed based on experience. Merely by way of example, in response to an index being {‘Index 1’ (‘concrete’), ‘Index 2’ (‘50 cm’), ‘Index 3’ (‘sludge’)}, since the estimated sedimentation thickness is large and pipe wall absorbency is strong, to ensure the penetrability, a query result may be a 250 kHz low-frequency sonar; and in response to an index being {‘Index 1’ (‘high-density polyethylene’), ‘Index 2’ (‘2 cm’), ‘Index 3’ (‘hard scaling’)}, since the estimated sedimentation thickness is small, to ensure the resolution, a query result may be a 1.2 MHz high-frequency sonar.

Embodiments of the present disclosure determine the sonar frequency based on the pipe material, the estimated sedimentation thickness, and the sedimentation type, which overcomes a problem of poor adaptability of a single sonar frequency in a complex environment, improves accuracy and reliability of the sonar detection data, and can accurately evaluate a sedimentation condition of the pipe in the target detection area.

In 270, a sedimentation risk may be determined based on the estimated sedimentation thickness, the sedimentation type, and the pipe characteristics.

The sedimentation risk refers to a risk caused by sediment in the pipe section. For example, the sedimentation risk may include complete blockage, sewage overflow, pipe wall damage, or the like.

In some embodiments, the emergency supervision management platform 120 may build a sedimentation vector based on the estimated sedimentation thickness, the sedimentation type, and the pipe characteristics; and determine the sedimentation risk by retrieving in the sedimentation database based on the sedimentation vector. The sedimentation database refers to a database used for storing, indexing, and querying vectors. Through the sedimentation database, similarity queries and other vector management may be quickly performed on a large count of the vectors. The sedimentation database may be stored in a database 1211.

In some embodiments, the emergency supervision management platform 120 may obtain a reference sedimentation thickness, a reference sedimentation type, and reference pipe characteristics of a reference pipe section based on the historical data, and build a plurality of reference sedimentation vectors based on the reference sedimentation thickness, the reference sedimentation type, and the reference pipe characteristics. Each reference sedimentation vector has a corresponding sedimentation label vector.

The sedimentation label vector may include a probability value for the occurrence of the sedimentation risk (e.g., the complete blockage, the sewage overflow, and the pipe wall damage), and be manually labeled based on the historical data. For example, if the sedimentation risk is the pipe wall damage, the sedimentation label vector may be represented as [0, 0, 1], which means that complete blockage and sewage overflow have not occurred, and pipe wall damage has occurred. The emergency supervision management platform 120 may store the plurality of reference sedimentation vectors and the corresponding sedimentation label vectors in the sedimentation database.

In some embodiments, the computing unit 1213 of the emergency supervision management platform 120 may determine a similarity (e.g., cosine similarity and Euclidean distance) between the sedimentation vector and the plurality of reference sedimentation vectors, and determine the sedimentation label vector of the reference sedimentation vector with the highest similarity as the sedimentation risk.

In some embodiments, the computing unit 1213 of the emergency supervision management platform may determine a similarity (e.g., cosine similarity and Euclidean distance) between the sedimentation vector and the plurality of reference sedimentation vectors, and sort the plurality of reference sedimentation vectors from largest to smallest based on the similarity. The emergency supervision management platform 120 may determine an average value of the sedimentation label vectors of top K (K is a positive integer greater than 1) reference sedimentation vectors as the sedimentation risk. K may be set based on experience or by the system. Merely by way of example, if K is 3, and the sedimentation label vectors of the first 3 reference sedimentation vectors are [1, 1, 0], [1, 0, 0], and [1, 1, 0], respectively, the sedimentation risk is [1, 0.67, 0].

In some embodiments, the emergency supervision management platform 120 may standardize and/or encode the estimated sedimentation thickness, the sedimentation type, and the pipe characteristics by Z-score standardization, Min-Max standardization, one-hot encoding, or the like, and build the sedimentation vector based on the standardized and/or encoded estimated sedimentation thickness, the sedimentation type, and the pipe characteristics.

In 280, a desilting path and desilting parameters may be automatically generated based on the sedimentation risk.

The desilting path refers to a path including at least one desilting operation point. In some embodiments, the desilting path may include an already desilted path and a pending desilting path. The already desilted path refers to a path where the desilting operation points on the path have completed the desilting operation. The pending desilting path refers to a path where there are desilting operation points waiting for the desilting operation on the path.

In some embodiments, at least one desilting operation point may constitute an operation point sequence. In some embodiments, the desilting path may be a topological structure of the pipes of the desilting operation points. The topological structure of the pipes may be obtained based on the drainage network information and the pipe characteristics. More descriptions regarding the pipe characteristics may be found in operation 260 and related descriptions thereof. More descriptions regarding the desilting operation points and the drainage network information may be found below and in related descriptions thereof.

The desilting parameters refer to equipment parameters when the automated desilting equipment performs the desilting operation. In some embodiments, the desilting parameters may include a travel speed and a desilting intensity of the automated desilting equipment. In some embodiments, the desilting parameters are related to a type of automated desilting equipment. For example, if the automated desilting equipment is a high-pressure water flow equipment, the desilting parameters may include hydraulic parameters (e.g., water pressure and flow rate), nozzle parameters (e.g., nozzle type and spray angle), water temperature, or the like. The nozzle type may include a standard cleaning nozzle, a rotary nozzle, or the like. As another example, if the automated desilting equipment is a vacuum suction equipment, the desilting parameters may include a power of a suction pump, a negative pressure value, a diameter of a suction pipe, or the like.

In some embodiments, it is known that there are two situations: the sedimentation risk being greater than a preset risk threshold, and the sedimentation risk being less than or equal to the preset risk threshold. In response to the sedimentation risk being greater than the preset risk threshold, the emergency supervision management platform 120 may automatically generate the desilting path and the desilting parameters based on the target detection area and the one or more adjacent pipe sections located upstream of the target detection area. The preset risk threshold may be set based on experience or by the system.

For example, the emergency supervision management platform 120 may obtain the drainage network information (e.g., the pipe characteristics, design drawings, and a network map) from the database 1211. Based on the drainage network information, the emergency supervision management platform 120 may obtain pipe distribution and pipe identifiers (e.g., inspection well numbers) of the target detection area and the one or more adjacent pipe sections located upstream of the target detection area. Based on the pipe distribution and the pipe identifiers (e.g., the inspection well numbers) of the target detection area and the one or more adjacent pipe sections located upstream of the target detection area, the emergency supervision management platform 120 may generate the desilting path by a Dijkstra algorithm and/or a genetic algorithm. More descriptions regarding the pipe characteristics may be found in operation 260 and related descriptions thereof.

For example, for the one or more adjacent pipe sections located upstream of the target detection area, the emergency supervision management platform 120 may respectively set the travel speed and the desilting intensity of the automated desilting equipment as a medium-speed travel (e.g., 1-2 m/s) and a medium desilting intensity (e.g., a water pressure of 10-20 MPa). For the target detection area, the emergency supervision management platform may respectively set the travel speed and the desilting intensity of the automated desilting equipment as a low-speed travel (e.g., 0.5-1 m/s) and a high desilting intensity (e.g., a water pressure of 20-30 MPa). More descriptions regarding the adjacent pipe section may be found in operation 220 and related descriptions thereof. More descriptions regarding the target detection area may be found in operation 240 and related descriptions thereof.

In some embodiments, the emergency supervision management platform 120 may determine the desilting operation points based on the sedimentation risk and automatically generate the desilting path and the desilting parameters based on the sedimentation risk, the desilting operation points, and the sedimentation type through a second preset table.

The desilting operation point refers to a location of the pipe section (e.g., the target detection area and the adjacent pipe section) that requires the desilting operation. In some embodiments, the desilting operation point may be characterized as a geospatial attribute of the pipe section. The geospatial attribute may include longitude and latitude, elevation, address description, or the like.

In some embodiments, in response to the sedimentation risk being greater than the preset risk threshold, the emergency supervision management platform 120 may determine the target detection area and the one or more adjacent pipe sections located upstream of the target detection area as the desilting operation points. The emergency supervision management platform 120 may obtain identifiers (e.g., the inspection numbers) of the target detection area and identifiers of the one or more adjacent pipe sections located upstream of the target detection area from the database 1211, and retrieve the GIS database based on the identifiers of the target detection area and the identifiers of the one or more adjacent pipe sections located upstream of the target detection area to obtain the geospatial attribute of the target detection area and the geospatial attribute of the one or more adjacent pipe sections located upstream of the target detection area.

The second preset table includes a correspondence relationship between the desilting operation points, the sedimentation risk, and the sedimentation type, and the desilting path and the desilting parameters. For example, the correspondence relationship may be represented as: {Index 1 (desilting operation point), Index 2 (sedimentation risk), Index 3 (sedimentation type)->Query Result (desilting path, desilting parameters)}. The second preset table may be built based on the historical data, for example, the historical desilting operation points, the historical sedimentation risk, and the historical sedimentation type, where a historical desilting effect and a historical desilting speed satisfy an expected desilting effect (e.g., no sedimentation residue) and a preset speed threshold, and the corresponding historical desilting path and historical desilting parameters. Merely by way of example, in response to an index being {Index 1 (MH101-MH102), Index 2 ([0.67 (complete blockage), 1 (sewage overflow), 0 (pipe wall damage)]), Index 3 (viscous sediment)}, a query result may be a topological structure of the pipes in the adjacent pipe section MH101-MH102 (e.g., the topological structure of the pipes with inspection well 101 of MH101 as a start point of the desilting path and inspection well 102 of MH102 as an end point of the desilting path), and the water pressure, the flow rate, the spray angle, and the water temperature.

In some embodiments, the emergency supervision management platform 120 may control the robot to acquire desilting data of an actual desilting process through the emergency supervision object platform 140; adjusts the desilting parameters based on the desilting data; and control the automated desilting equipment to perform the desilting operation based on the adjusted desilting parameters through the emergency supervision object platform 140.

The desilting data refers to data related to the desilting operation. For example, the desilting data may include desilting duration, desilting power, and desilting volume.

In some embodiments, the emergency supervision management platform 120 may adjust the desilting parameters based on the desilting data through a preset adjustment rule. The preset adjustment rule may include a percentage of rated power and a preset desilting efficiency (e.g., 0.1 kg/s).

In some embodiments, it is known that there are two conditions: the desilting power is greater than the percentage of rated power, and the desilting power is less than or equal to the percentage of rated power. In some embodiments, it is known that there are two conditions: the desilting efficiency is greater than the preset desilting efficiency, and the desilting efficiency is less than or equal to the preset desilting efficiency. For example, if the desilting power is higher than 80% of the rated power and the desilting efficiency is less than the preset desilting efficiency, the emergency supervision management platform 120 may control the automated desilting equipment to pause operation through the emergency supervision object platform 140, and upload alarm information to the emergency supervision service platform 110.

For example, if the desilting power is higher than 80% of the rated power and the desilting efficiency is greater than the preset desilting efficiency, the emergency supervision management platform may decrease the travel speed and increase the desilting intensity. For example, if the desilting power is lower than 30% of the rated power, the emergency supervision management platform may increase the travel speed and decrease the desilting intensity. The desilting efficiency may be the ratio of the desilting volume and the desilting duration.

The embodiments of the present disclosure dynamically adjust the desilting parameters based on the desilting power, the desilting duration, and the desilting volume. This improves the ability to cope with unexpected situations during the desilting operation, and enhances the efficiency and safety of the desilting operation. In some embodiments, it reduces the power consumption and invalid operation duration of the automated desilting equipment, thereby achieving intelligent desilting.

In 290, automated desilting equipment may be controlled, by the emergency supervision object platform 140, to travel along the desilting path to a desilting operation point, and a desilting operation may be performed based on the desilting parameters.

In some embodiments, the emergency supervision management platform 120 may send a guidance instruction to the emergency supervision object platform 140 through the emergency supervision sensing network platform 130. The guidance instruction may include the desilting parameters. The emergency supervision object platform 140 may send the guidance instruction to the automated desilting equipment through a wireless network, to control the automated desilting equipment to travel along the desilting path to the desilting operation point, and perform the desilting operation based on the desilting parameters. More descriptions regarding the desilting path, the desilting parameters, and the desilting operation point may be found in operation 280 and related descriptions thereof.

In some embodiments, the emergency supervision management platform 120 may acquire pipe image data of the pipe section by an image acquisition device; determine an estimated sedimentation rate of a pipe in the pipe section based on pipe image date; and perform the desilting operation on the pipe in the pipe section based on the estimated sedimentation rate. In some embodiments, the image acquisition device is deployed in the drainage network.

The image acquisition device is used for acquiring images, videos, and 3D data inside the pipe of the pipe section. In some embodiments, the image acquisition device may include a camera, a pipe endoscope, a laser scanner, and a 3D imaging device.

The pipe image data is used for evaluating the structural state of the pipe (e.g., sedimentation, cracks, corrosion, and deformation). For example, the pipe image data may include images, videos, 3D data, and acquisition time points inside the pipe.

The process of acquiring pipe image data by the image acquisition device is similar to the process of acquiring flow data by the acquisition device. More descriptions may be found in operation 210 and related descriptions thereof.

The estimated sedimentation rate refers to a pre-estimated accumulation rate of sediments (e.g., silt, sludge, and debris) in the pipe. For example, the estimated sedimentation rate may be 0.2 cm/week.

In some embodiments, the emergency supervision management platform may determine the estimated sedimentation rate of the pipe in the pipe section based on pipe image data through an image processing model. The input of the image processing model may include pipe image data, and the output of the image processing model may be the estimated sedimentation rate.

In some embodiments, the image processing model may be obtained through training based on at least one set of first training samples and their corresponding first labels. The first training samples may be constructed based on historical image data, and the historical image data may be acquired from the database 1211. The first training samples may include at least one set of sample pipe image data of a sample pipe section, and the first labels may be the sedimentation rate of the sample pipe section.

In some embodiments, the first labels may be determined based on historical data of the sample pipe section, and be labeled. For example, under conditions similar to the sample pipe image data, the emergency supervision management platform 120 may mark the historical sedimentation rate of the sample pipe section as a sample sedimentation rate. The training process of the image processing model is similar to the training process of the sedimentation model. More descriptions may be found in FIG. 4 and related descriptions thereof.

In some embodiments, it is known that there are two conditions: the estimated sedimentation rate is greater than a preset rate threshold, and the estimated sedimentation rate is less than or equal to the preset rate threshold. In response to the estimated sedimentation rate being greater than the preset rate threshold, the emergency supervision management platform 120 may generate a desilting operation instruction. The emergency supervision management platform 120 may send the desilting operation instruction to the emergency supervision object platform 140 through the emergency supervision sensing network platform 130, and send the desilting operation instruction to the automated desilting equipment through the emergency supervision object platform 140, to control the automated desilting equipment to perform the desilting operation on the pipe in the pipe section. In response to the estimated sedimentation rate being less than or equal to the preset rate threshold, the emergency supervision management platform 120 may not issue the desilting operation instruction, and obtain the relationship between the estimated sedimentation rate and the preset rate threshold by the computing unit 1213 at a preset period.

In some embodiments, the emergency supervision management platform 120 may determine, based on the estimated sedimentation rate, whether a candidate pipe section located on a pending desilting path in the pipe section satisfies a preset condition. In some embodiments, in response to the candidate pipe section satisfying the preset condition, the emergency supervision management platform 120 may determine the candidate pipe section as an additional operation point; and control, by the emergency supervision object platform 140, the automated desilting equipment to travel along the desilting path to the additional operation point, and perform the desilting operation.

More descriptions regarding the desilting path and the pending desilting path may be found in operation 280 and related descriptions thereof. The additional operation point is similar to the desilting operation point. More descriptions may be found in a desilting operation point and related descriptions thereof. More descriptions regarding the automated desilting equipment may be found in FIG. 1 and related descriptions thereof.

The candidate pipe section refers to a pipe section to be selected that is not included in the operation point sequence. In some embodiments, the candidate pipe section may be the adjacent pipe section of a pipe section for which desilting has been completed. More descriptions regarding the adjacent pipe section may be found in operation 220 and related descriptions thereof. More descriptions regarding the operation point sequence may be found in operation 280 and related descriptions thereof.

The preset condition refers to the condition for the candidate pipe section to become an additional operation point. In some embodiments, the preset condition may be that the estimated sedimentation rate of the pipe in the candidate pipe section is greater than the preset rate threshold.

In some embodiments, the emergency supervision management platform 120 may determine the estimated sedimentation rate of the pipe in the candidate pipe section based on pipe image data of the candidate pipe section through the image processing model. In response to the estimated sedimentation rate of the pipe in the candidate pipe section satisfying the preset condition, the emergency supervision management platform 120 may determine the candidate pipe section as the additional operation point. A process of determining the estimated sedimentation rate of the pipe in the candidate pipe section may be found above and in related descriptions thereof.

In some embodiments, the emergency supervision management platform 120 may control, by the emergency supervision object platform 140, the automated desilting equipment to travel along the desilting path from a current desilting operation point (that is, an operation point for which desilting has been completed) to a next desilting operation point. The next desilting operation point may be a desilting operation point closest to the current desilting operation point, or may be the additional operation point. A process of controlling, by the emergency supervision object platform, the automated desilting equipment to travel along the desilting path to the additional operation point and perform the desilting operation may be found in operation 290 above and related descriptions thereof.

The embodiments of the present disclosure determine, based on the estimated sedimentation rate and the preset rate threshold, whether to determine the pipe section located on the pending desilting path as the additional operation point. This enables prioritizing the deployment of desilting operation points in high-risk pipe sections, thereby reducing the maintenance cost of the drainage network and improving the desilting efficiency.

The embodiments of the present disclosure estimate the sedimentation rate through pipe image data, which solves the problem that a traditional pipe maintenance approach cannot foresee the sedimentation risk. This realizes a transition from ‘passive response’ to ‘proactive predictive maintenance’, and reduces the possibility of sewage overflow caused by re-clogging of the pipes.

The embodiments of the present disclosure evaluate the sedimentation risk and automatically complete the desilting operation of the pipe section by acquiring the flow data and the sonar detection data. This builds a monitoring and management system that transitions from ‘passive discovery’ to ‘proactive early warning’ and then to ‘intelligent desilting’, which solves the problem of disjointed traditional drainage network maintenance workflows, delayed responses, and heavy reliance on manual experience. Through data-driven decisions, it significantly improves the systematization, intelligence, and overall operation and maintenance efficiency of drainage network management.

FIG. 3 is a schematic diagram of an exemplary process for determining a target detection area according to some embodiments of the present disclosure.

In some embodiments, as shown in FIG. 3, for N anomalous pipe sections 320 (where N is a positive integer greater than 1), the emergency supervision management platform 120 may screen anomalous pipe sections 320 by a preset filtering condition 310 based on precipitation 311 within a preset time period, a restaurant wastewater discharge 312 upstream of the anomalous pipe section, and a construction wastewater discharge 313; determine an anomalous flow cross-sectional area series 340 based on screened anomalous pipe sections 330; and determine a target detection area 370 based on the anomalous flow cross-sectional area series 340.

The preset time period refers to a preset current or future time range. For example, the preset time period may be 9:00 to 21:00 on the current day or a future day. In some embodiments, the preset time period is prior to the anomalous flow passage moment. More descriptions regarding the anomalous flow passage moment may be found in FIG. 2 and related descriptions thereof.

The precipitation refers to a water layer depth accumulated within a drainage area of the anomalous pipe section 320 during the preset time period. For example, within 24 hours, the precipitation within the drainage area of the anomalous pipe section 320 is 35 mm. In some embodiments, the emergency supervision service platform 120 may obtain minute-level or hour-level precipitation published by an urban meteorological monitoring station through an Application Programming Interface (API) of a meteorological department, and send the precipitation to the emergency supervision service platform 110.

The restaurant wastewater discharge refers to a total volume of wastewater and/or solid waste (e.g., kitchen waste) generated by catering entities upstream of the anomalous pipe section 320 during their operation within the preset time period. For example, within 24 hours, the restaurant wastewater discharge upstream of the anomalous pipe section 320 is 240 m³ (i.e., 0.003 m³/s). In some embodiments, the emergency supervision management platform 120 may obtain the restaurant wastewater discharge through the flowmeter deployed at wastewater discharge outlets of the catering entities.

The construction wastewater discharge refers to a total volume of wastewater and/or solid waste (e.g., construction waste, slag) generated by construction activities such as building construction, municipal construction, and demolition projects upstream of the anomalous pipe section 320 within the preset time period. For example, within 24 hours, the construction wastewater discharge upstream of the anomalous pipe section 320 is 100 m³ (i.e., 0.001 m³/s). In some embodiments, the emergency supervision management platform may obtain the construction wastewater discharge through the flowmeter deployed at construction wastewater discharge outlets.

The preset filtering condition refers to conditions preset for screening the anomalous pipe sections. In some embodiments, the preset filtering condition 310 may be that a sum of normalized precipitation, normalized restaurant wastewater discharge, and normalized construction wastewater discharge within the preset time period satisfies being less than a preset flow threshold. The preset flow threshold may be set based on experience or by a system.

In some embodiments, the emergency supervision management platform 120 may convert the precipitation into runoff flow (m³/s) through a hydrological model. The runoff flow may be expressed as formula (2):

$$Q = C \times I \times A , \qquad ( 2 )$$

Q is the runoff flow, C is a runoff coefficient, I is a rainfall intensity (m/s), and A is a drainage area of the anomalous pipe section (m²). The runoff coefficient may be determined by a surface type. For example, the runoff coefficient of asphalt pavement is 0.9. The drainage area of the anomalous pipe section 320 may be obtained from the GIS database.

In some embodiments, in response to a sum of the normalized precipitation, the normalized restaurant wastewater discharge, and the normalized construction wastewater discharge corresponding to the anomalous pipe section 320 within the preset time period satisfying the preset filtering condition 310, the emergency supervision management platform 120 may determine the anomalous pipe section 320 as the screened anomalous pipe section 330. More descriptions regarding the anomalous pipe section may be found in FIG. 2 and related descriptions thereof.

The anomalous flow cross-sectional area series refers to a numerical sequence composed of at least one anomalous flow area. In some embodiments, the anomalous flow area may be the flow area of the anomalous flow passage moment.

In some embodiments, the emergency supervision management platform 120 may determine the anomalous flow areas respectively corresponding to a plurality of screened anomalous pipe sections 330 at the same anomalous flow passage moment as the anomalous flow cross-sectional area series 340. In some embodiments, the emergency supervision management platform 120 may determine the anomalous flow areas of the screened anomalous pipe section 330 at a plurality of anomalous flow passage moments as the anomalous flow cross-sectional area series 340 of the screened anomalous pipe section 330. More descriptions regarding the anomalous flow passage moment and the flow area may be found in FIG. 2 and related descriptions thereof.

In some embodiments, in response to the anomalous flow cross-sectional area series 340 including the anomalous flow areas respectively corresponding to the plurality of screened anomalous pipe sections 330 at the same anomalous flow passage moment, and one anomalous flow area in the anomalous flow cross-sectional area series 340 being significantly less than a flow area threshold (e.g., less than 60% of the flow area threshold), the emergency supervision management platform 120 may obtain the anomalous pipe section corresponding to the anomalous flow area, and determine the anomalous pipe section and the adjacent pipe section upstream of the anomalous pipe section as the target detection area 370. In some embodiments, the emergency supervision management platform 120 may directly determine the anomalous pipe section corresponding to the anomalous flow area as the target detection area 370.

In some embodiments, for one of the plurality of screened anomalous pipe sections 330, in response to a mean of the anomalous flow areas in the anomalous flow cross-sectional area series 340 corresponding to the screened anomalous pipe section 330 being significantly less than the flow area threshold (e.g., less than 60% of the flow area threshold), the emergency supervision management platform 120 may determine the screened anomalous pipe section 330 and/or the adjacent pipe section upstream of the screened anomalous pipe section 330 as the target detection area 370. In some embodiments, the emergency supervision management platform 120 may directly determine the screened anomalous pipe section 330 as the target detection area 370. More descriptions regarding the flow area threshold, the adjacent pipe section, and the target detection area may be found in FIG. 2 and related descriptions thereof.

In some embodiments, as shown in FIG. 3, the emergency supervision management platform 120 may determine flow fluctuation information 350 based on historical precipitation 351, a historical restaurant wastewater discharge 352, and a historical construction wastewater discharge 353; determine whether a pseudo-abnormal flow area exists in the anomalous flow cross-sectional area series 340 based on the flow fluctuation information 350, the emergency supervision management platform. In response to existence of the pseudo-abnormal flow area, the emergency supervision management platform 120 may remove the pseudo-abnormal flow area from the anomalous flow cross-sectional area series 340 to generate an updated anomalous flow cross-sectional area series 360; determine the target detection area 370 based on the updated anomalous flow cross-sectional area series 360.

The historical precipitation 351, the historical restaurant wastewater discharge 352, and the historical construction wastewater discharge 353 are similar to the precipitation, the restaurant wastewater discharge, and the construction wastewater discharge. More descriptions may be found above and in related descriptions thereof. In some embodiments, the emergency supervision management platform 120 may obtain historical data from the database 1211, and obtain the historical precipitation 351, the historical restaurant wastewater discharge 352, and the historical construction wastewater discharge 353 based on the historical data.

The flow fluctuation information refers to a flow fluctuation situation or fluctuation regularity of the pipe section under conditions where pipe drainage capacity of a pipe in the pipe section is normal (e.g., no sedimentation in the pipe, no damage to the pipe) and external environmental factors (e.g., precipitation, restaurant wastewater discharge, construction wastewater discharge) exist. In some embodiments, the flow fluctuation information 350 may be the flow fluctuation situation or fluctuation regularity presented by the flow cross-sectional area series of the pipe section within the preset time period. More descriptions regarding the flow cross-sectional area series may be found in FIG. 2 and related descriptions thereof. More descriptions regarding the preset time period may be found above and in related descriptions thereof.

In some embodiments, the emergency supervision management platform 120 may construct a fluctuation information database based on the historical precipitation 351, the historical restaurant wastewater discharge 352, and the historical construction wastewater discharge 353, and determine the flow fluctuation information 350 by retrieving the fluctuation information database. The emergency supervision management platform 120 may obtain the historical precipitation 351, the historical restaurant wastewater discharge 352, and the historical construction wastewater discharge 353 of a plurality of historical time periods based on the historical data. The emergency supervision management platform may construct a plurality of reference fluctuation vectors based on the historical precipitation 351, the historical restaurant wastewater discharge 352, and the historical construction wastewater discharge 353 of the plurality of historical time periods. Each reference fluctuation vector has a corresponding fluctuation tag. The fluctuation tag may be the historical flow fluctuation information corresponding to the historical time period of the reference fluctuation vector, and is manually labeled based on the historical data. The historical flow fluctuation information is similar to the flow fluctuation information 350. More descriptions may be found in flow fluctuation information and related descriptions thereof. The emergency supervision management platform 120 may store the plurality of reference fluctuation vectors and the corresponding fluctuation tags in the fluctuation information database.

In some embodiments, the emergency supervision management platform 120 may construct a target vector based on the precipitation 311, the restaurant wastewater discharge 312 upstream of the anomalous pipe section, and the construction wastewater discharge 313 within the preset time period. The computing unit 1213 of the emergency supervision management platform 120 may determine a similarity (e.g., cosine similarity, Euclidean distance) between the target vector and the plurality of reference fluctuation vectors, and determine the fluctuation tag of the reference fluctuation vector with the highest similarity as the flow fluctuation information 350. In some embodiments, the time length of the plurality of historical time periods may be the same as the preset time period. For example, if the preset time period is 24 hours of one day (i.e., 0:00 to 24:00), then the plurality of historical time periods may be the 24 hours of each day of the past 30 days.

The pseudo-abnormal flow area refers to a surface-abnormal flow area caused by other factors (e.g., measurement error, calculation method difference, seasonal variation). For example, during the dry season, the flow area of the pipe section is 50 m². After entering the flood season, due to an increase in the precipitation, the flow area of the pipe section becomes 80 m². If determined as an ‘abnormal increase’ solely based on a numerical change, it may be a misjudgment. In fact, the increase in the flow area of the pipe section is a normal manifestation of seasonal hydrological characteristics, not a true anomaly. The ‘anomalous flow area’ may be corrected through historical data comparison or long-term monitoring.

In some embodiments, the emergency supervision management platform 120 may obtain a fitting function of the flow fluctuation information based on the flow fluctuation information 350 through a first fitting model. The first fitting model may include a linear regression model (e.g., a least squares process), non-linear fitting (e.g., exponential fitting, polynomial fitting), and a time series model (e.g., an Autoregressive Integrated Moving Average (ARIMA) model, moving average, exponential smoothing), or the like. The emergency supervision management platform 120 may determine a prediction sequence corresponding to the anomalous flow cross-sectional area series 340 through the fitting function. The predicted values in the prediction sequence correspond one-to-one to the anomalous flow areas in the anomalous flow cross-sectional area series 340.

For one anomalous flow area in the anomalous flow cross-sectional area series 340, the emergency supervision management platform 120 may determine a difference between the anomalous flow area and a corresponding predicted value, and determine whether the difference is less than a deviation threshold. It is known that there are two cases: the difference between the anomalous flow area and the corresponding predicted value is less than the deviation threshold, and the difference between the anomalous flow area and the corresponding predicted value is greater than or equal to the deviation threshold. In response to the difference between the anomalous flow area and the corresponding predicted value being less than the deviation threshold, the emergency supervision management platform 120 may determine the anomalous flow area corresponding to the difference as the pseudo-abnormal flow area, and remove the pseudo-abnormal flow area from the anomalous flow cross-sectional area series 340 to generate the updated anomalous flow cross-sectional area series 360. The deviation threshold may be set based on experience or by a system.

A process of determining the target detection area 370 based on the updated anomalous flow cross-sectional area series 360 is similar to a process of determining the target detection area 370 based on the anomalous flow cross-sectional area series 340. More descriptions may be found above and in related descriptions thereof.

The embodiments of the present disclosure remove the pseudo-abnormal flow area existing in the anomalous flow cross-sectional area series based on the flow fluctuation information, which reduces the possibility of misjudgment and improves the efficiency of the desilting operation.

The embodiments of the present disclosure analyze a flow anomaly of the anomalous pipe section based on external environmental data such as the precipitation, the restaurant wastewater discharge, and the construction wastewater discharge. The embodiments further consider the influence of external environmental factors, such as heavy rainfall and peak wastewater discharge, on the pipe drainage capacity, which reduces the cost of ineffective desilting operations caused by false alarms, and significantly improves the accuracy and credibility of a drainage capacity warning.

FIG. 4 is a schematic diagram of an exemplary sedimentation model according to some embodiments of the present disclosure.

In some embodiments, as shown in FIG. 4, the emergency supervision management platform 120 may determine a detection density 420 in a circumferential direction of pipe in the target detection area based on a variation amplitude of the anomalous flow cross-sectional area series 340 relative to a normal flow cross-sectional area series 410; control, by the emergency supervision object platform 140, the robot to perform detection on the target detection area based on a detection density 420, and acquire sonar detection data 430; and generate an estimated sedimentation thickness 451 and a sedimentation type 452 of the target detection area by processing the sonar detection data 430 of a plurality of circumferential measurement points in the target detection area and pipe characteristics 440 through a sedimentation model 450.

The normal flow cross-sectional area series refers to a numerical sequence formed by at least one normal flow area. The normal flow area refers to the flow area of the pipe section under conventional hydrological conditions and without anomalous events (e.g., flooding, blockage, or pipe structural damage, etc.). The conventional hydrological conditions refer to a state where hydrological elements (e.g., precipitation, water level, flow, or evaporation, etc.) present periodic and predictable natural fluctuations, and are not affected by extreme events (e.g., flooding, drought, or geological disasters, etc.) or human anomalous interference (e.g., engineering failures or irregular operations, etc.). In some embodiments, the determination of the normal flow cross-sectional area series 410 is similar to the determination of the flow fluctuation information, more descriptions may be found in FIG. 3 and related descriptions thereof. In some embodiments, the emergency supervision management platform 120 may obtain the normal flow cross-sectional area series 410 from the database 1211.

The variation amplitude of the anomalous flow cross-sectional area series 340 relative to the normal flow cross-sectional area series 410 refers to the deviation degree of the anomalous flow cross-sectional area series 340 relative to the normal flow cross-sectional area series 410. In some embodiments, the emergency supervision management platform may, based on the anomalous flow cross-sectional area series 340 and the normal flow cross-sectional area series 410, respectively obtain an anomalous fitting curve and a normal fitting curve through a second fitting model. The fitting model may include a linear regression model (e.g., a least squares process), nonlinear fitting (e.g., exponential fitting or polynomial fitting), or a time series model (e.g., an ARIMA model, moving average, exponential smoothing), or the like. The emergency supervision management platform 120 may determine, based on a mean square error, a root mean square error, a mean absolute error, a coefficient of determination, a maximum deviation, etc., of the anomalous fitting curve and the normal fitting curve, the variation amplitude of the anomalous flow cross-sectional area series 340 relative to the normal flow cross-sectional area series 410. More descriptions regarding the anomalous flow cross-sectional area series may be found in FIG. 3 and related descriptions thereof.

The detection density in the circumferential direction of pipe refers to a count of echo points collected by the sonar sensor when performing scanning inside a pipe, around a circumference (360 degrees) of a pipe cross-section. For example, the detection density 420 in the circumferential direction of pipe may be 128 echo points/circle or 512 echo points/circle.

In some embodiments, it is known that there are two situations: the variation amplitude of the anomalous flow cross-sectional area series 340 relative to the normal flow cross-sectional area series 410 is greater than a preset amplitude threshold, and the variation amplitude of the anomalous flow cross-sectional area series 340 relative to the normal flow cross-sectional area series 410 is less than or equal to the preset amplitude threshold. In response to the variation amplitude of the anomalous flow cross-sectional area series 340 relative to the normal flow cross-sectional area series 410 being greater than the preset amplitude threshold, the emergency supervision management platform 120 may determine the detection density 420 in the circumferential direction of pipe in the target detection area as high-density detection (e.g., 512 data points/circle); in response to the variation amplitude of the anomalous flow cross-sectional area series 340 relative to the normal flow cross-sectional area series 410 being less than or equal to the preset amplitude threshold, the emergency supervision management platform 120 may determine the detection density 420 in the circumferential direction of pipe in the target detection area as low-density detection (e.g., 128 data points/circle). The preset amplitude threshold may be set based on experience, or by the system.

In some embodiments, the emergency supervision management platform 120 may, through the emergency supervision sensing network platform 130, send the guidance instructions to the emergency supervision object platform 140. The guidance instructions may include the detection density 420 in the circumferential direction of pipe. The emergency supervision object platform 140 may send the guidance instructions to the robot through the wireless network. The robot configures a operating mode of the sonar sensor based on the detection density 420 in the circumferential direction of pipe in the guidance instructions (e.g., a count of data points collected per rotation). The sonar sensor may perform detection on the target detection area and acquire the sonar detection data 430 based on the configured operating mode. More descriptions regarding the robot and the sonar sensor may be found in FIG. 1 and related descriptions thereof. More descriptions regarding the target detection area and the sonar detection data may be found in FIG. 2 and related descriptions thereof.

In some embodiments, an input of the sedimentation model 450 may include the sonar detection data 430 of the plurality of circumferential measurement points and the pipe characteristics 440, and an output of the sedimentation model 450 may include the estimated sedimentation thickness 451 and the sedimentation type 452 of the target detection area. In some embodiments, the sedimentation model 450 may be a machine learning model. The sedimentation model 450 may include a Convolutional Neural Network (CNN), a Recurrent Neural Network (RNN), etc.

In some embodiments, the plurality of circumferential measurement points refer to a plurality of echo points distributed in the circumferential direction of a pipe. In some embodiments, the plurality of circumferential measurement points refer to a plurality of echo points distributed along the circumferential direction at multiple positions along the pipe and along the circumference direction of the pipe. More descriptions regarding the echo points may be found in FIG. 2 and related descriptions thereof.

In some embodiments, the sedimentation model 450 may be obtained through training based on at least one set of second training samples and corresponding second labels. In some embodiments, the second training samples may be constructed based on historical data, and the historical data may be obtained from the database 1211. The second training samples may include sonar detection data of at least one set of sample circumferential measurement points of a sample pipe section and sample pipe characteristics, and the second labels may be sedimentation thickness and sedimentation type of the sample pipe section. In some embodiments, the second labels may be determined based on the historical data of the sample pipe section, and be labeled. For example, under conditions similar to the sample pipe characteristics, the emergency supervision management platform 120 may mark the historical sedimentation thickness and the historical sedimentation type of the sample pipe section as sedimentation thickness and sedimentation type of the sample pipe section.

During training, the second training samples are input to an initial sedimentation model, a loss function is constructed based on the output of the initial sedimentation model and the second labels, the parameters of the initial sedimentation model are iteratively updated (e.g., a gradient descent manner) based on the loss function until a preset training condition is satisfied, then the training ends, a trained sedimentation model is obtained, and the trained sedimentation model is used as the sedimentation model 450. The preset training condition may include, but is not limited to, convergence of the loss function, a training period reaching a threshold, etc.

In some embodiments, the emergency supervision management platform 120 may perform standardization and/or encoding on the sonar detection data 430 of a plurality of circumferential measurement points and the pipe characteristics 440 by Z-score standardization, Min-Max standardization, one-hot encoding, etc., and use standardized and/or encoded sonar detection data of a plurality of circumferential measurement points and standardized and/or encoded pipe characteristics as the input of the sedimentation model 450.

More descriptions regarding the sonar detection data, pipe characteristics, the target detection area, the estimated sedimentation thickness, and the sedimentation type may be found in FIG. 2 and related descriptions thereof.

In some embodiments, the emergency supervision management platform may determine a desilting accuracy rate 460 based on the estimated sedimentation thickness 451 and the sedimentation type 452; determine an associated pipe section 470 corresponding to the target detection area based on the desilting accuracy rate 460; and control the robot to perform detection on the associated pipe section 470 through the emergency supervision object platform 140.

The desilting accuracy rate is used for evaluating the matching degree between the output of the sedimentation model 450 and actual desilting data (e.g., actual sedimentation thickness or actual sedimentation type). For example, the desilting accuracy rate 460 may be expressed as a percentage.

In some embodiments, the robot may upload actual sedimentation thickness and actual sedimentation type collected after completing a desilting operation to the emergency supervision object platform 140. The emergency supervision object platform 140 may upload the actual sedimentation thickness and the actual sedimentation type to the emergency supervision management platform 120 through the emergency supervision sensing network platform 130. The emergency supervision management platform may determine the desilting accuracy rate 460 based on the estimated sedimentation thickness 451 and the sedimentation type 452 output by the sedimentation model 450, as well as the actual sedimentation thickness, and actual sedimentation type. For example, the desilting accuracy rate 460 may be characterized as:

[|the actual sedimentation thickness−the estimated sedimentation thickness|/the estimated sedimentation thickness]×μ×100%,

wherein μ is a penalty factor. The penalty factor is used to penalizingly reduce the desilting accuracy rate 460. When the sedimentation type 452 output by the sedimentation model 450 does not match the actual sedimentation type, the emergency supervision management platform 120 may reduce the desilting accuracy rate 460 by the penalty factor μ. μ may be set based on experience, or by the system.

The associated pipe section refers to other pipe sections associated with the target detection area. In some embodiments, the associated pipe section 470 may include one or more pipe sections upstream of the target detection area and/or one or more pipe sections downstream of the target detection area.

In some embodiments, it is known that there are two situations: the desilting accuracy rate 460 is within a preset range [a %, b %], and the desilting accuracy rate 460 is outside the preset range [a %, b %]. In response to the desilting accuracy rate 460 being within the preset range, the emergency supervision management platform 120 may determine that the output of the sedimentation model 450 is accurate. In response to the desilting accuracy rate 460 being less than a %, the emergency supervision management platform 120 may determine one or more pipe sections downstream of the target detection area as the associated pipe section 470 of the target detection area. In response to the desilting accuracy rate 460 being greater than b %, the emergency supervision management platform 120 may determine one or more pipe sections upstream of the target detection area as the associated pipe section 470 of the target detection area. a % and b % may be set based on experience, or by the system. In some embodiments, a % may be set as a negative value, and b % may be set as a positive value. For example, a % may be set as −20%, and b % may be set as 20%.

Detection of the associated pipe section is similar to detection of the target detection area, more descriptions may be found in FIG. 2 and related descriptions thereof.

Embodiments of the present disclosure, by evaluating the accuracy of the output of the sedimentation model, establish a feedback correction closed-loop and improve desilting efficiency. Meanwhile, embodiments of the present disclosure can, based on the accuracy of the output of the sedimentation model, intelligently trace and locate omitted pipe sections, and improve the depth and accuracy of drainage network problem investigation.

Embodiments of the present disclosure, based on the variation amplitude of the anomalous flow cross-sectional area series relative to the normal flow cross-sectional area series, adjust the detection density of the sonar detection data, and improve detection efficiency for the target detection area. Meanwhile, embodiments of the present disclosure, based on the sonar detection data of the plurality of circumferential measurement points and the pipe characteristics, use the trained sedimentation model to estimate the sedimentation thickness and the sedimentation type, can, in combination with actual conditions, more accurately estimate the sedimentation condition of the target detection area, and reduce manpower cost and resource waste required for manual evaluation.

Basic concepts have been described above, and it is apparent to those skilled in the art that the detailed disclosure above is merely for illustration and does not constitute a limitation on the present disclosure. Although not explicitly stated herein, those skilled in the art may make various modifications, improvements, and revisions to the present disclosure. Such modifications, improvements, and revisions are suggested in the present disclosure, so such modifications, improvements, and revisions still fall within the spirit and scope of the exemplary embodiments of the present disclosure.

What is claimed is:

1. A drainage network sedimentation management system based on a large Internet of Things (IoT) model, comprising an emergency supervision management platform and an emergency supervision object platform, wherein the emergency supervision management platform is configured to:
acquire flow data of a pipe section by an acquisition device deployed in a drainage network, and obtain the flow data uploaded by the acquisition device;
determine a flow cross-sectional area series of a plurality of adjacent pipe sections based on the flow data of the pipe section;
determine an anomalous pipe section and an anomalous flow passage moment based on the flow cross-sectional area series of the plurality of adjacent pipe sections;
determine a target detection area and a target detection time based on the anomalous pipe section and the anomalous flow passage moment;
control, by the emergency supervision object platform, a robot to perform sonar detection on the target detection area at the target detection time, and acquire sonar detection data, wherein the robot is equipped with a sonar sensor;
generate an estimated sedimentation thickness and a sedimentation type of the target detection area based on the sonar detection data and pipe characteristics;
determine a sedimentation risk based on the estimated sedimentation thickness, the sedimentation type, and the pipe characteristics;
automatically generate a desilting path and desilting parameters based on the sedimentation risk;
control, by the emergency supervision object platform, automated desilting equipment to travel along the desilting path to a desilting operation point, and perform a desilting operation based on the desilting parameters.

2. The drainage network sedimentation management system according to claim 1, wherein sonar frequencies of a plurality of pipe sections are different, and the emergency supervision management platform is further configured to:
determine a sonar frequency of the pipe section based on a pipe material, the estimated sedimentation thickness, and the sedimentation type.

3. The drainage network sedimentation management system according to claim 1, wherein the emergency supervision management platform is further configured to:
screen the anomalous pipe section by a preset filtering condition based on precipitation within a preset time period, a restaurant wastewater discharge upstream of the anomalous pipe section, and a construction wastewater discharge, wherein the preset time period is prior to the anomalous flow passage moment;
determine an anomalous flow cross-sectional area series based on the screened anomalous pipe section;
determine the target detection area based on the anomalous flow cross-sectional area series.

4. The drainage network sedimentation management system according to claim 3, wherein the emergency supervision management platform is further configured to:
determine flow fluctuation information based on historical precipitation, a historical restaurant wastewater discharge, and a historical construction wastewater discharge;
determine, based on the flow fluctuation information, whether a pseudo-abnormal flow area exists in the anomalous flow cross-sectional area series;
in response to existence of the pseudo-abnormal flow area, remove the pseudo-abnormal flow area from the anomalous flow cross-sectional area series to generate an updated anomalous flow cross-sectional area series;
determine the target detection area based on the updated anomalous flow cross-sectional area series.

5. The drainage network sedimentation management system according to claim 3, wherein the emergency supervision management platform is further configured to:
determine a detection density in a circumferential direction of pipe in the target detection area based on a variation amplitude of the anomalous flow cross-sectional area series relative to a normal flow cross-sectional area series;
control, by the emergency supervision object platform, the robot to perform detection on the target detection area based on the detection density, and acquire the sonar detection data;
generate the estimated sedimentation thickness and the sedimentation type of the target detection area by processing sonar detection data of a plurality of circumferential measurement points in the target detection area and the pipe characteristics through a sedimentation model, wherein the sedimentation model is a machine learning model.

6. The drainage network sedimentation management system according to claim 5, wherein the emergency supervision management platform is further configured to:
determine a desilting accuracy rate based on the estimated sedimentation thickness and the sedimentation type;
determine an associated pipe section corresponding to the target detection area based on the desilting accuracy rate;
control, by the emergency supervision object platform, the robot to perform detection on the associated pipe section.

7. The drainage network sedimentation management system according to claim 1, wherein the emergency supervision management platform is further configured to:
control, by the emergency supervision object platform, the robot to acquire desilting data of an actual desilting process;
adjust the desilting parameters based on the desilting data;
control, by the emergency supervision object platform, the automated desilting equipment to perform the desilting operation based on the adjusted desilting parameters.

8. The drainage network sedimentation management system according to claim 7, wherein the emergency supervision management platform is further configured to:
acquire pipe image data of the pipe section by an image acquisition device;
determine an estimated sedimentation rate of a pipe in the pipe section based on the pipe image data;
perform the desilting operation on the pipe in the pipe section based on the estimated sedimentation rate.

9. The drainage network sedimentation management system according to claim 8, wherein the emergency supervision management platform is further configured to:
determine, based on the estimated sedimentation rate, whether a candidate pipe section located on a pending desilting path in the pipe section satisfies a preset condition;
in response to the candidate pipe section satisfying the preset condition, determine the candidate pipe section as an additional operation point;
control, by the emergency supervision object platform, the automated desilting equipment to travel along the desilting path to the additional operation point to perform the desilting operation.

10. A drainage network sedimentation management method based on a large Internet of Things (IoT) model, wherein the method is executed by an emergency supervision management platform, and the method comprises:
acquiring flow data of a pipe section by an acquisition device deployed in a drainage network, and obtaining the flow data uploaded by the acquisition device;
determining a flow cross-sectional area series of a plurality of adjacent pipe sections based on the flow data of the pipe section;
determining an anomalous pipe section and an anomalous flow passage moment based on the flow cross-sectional area series of the plurality of adjacent pipe sections;
determining a target detection area and a target detection time based on the anomalous pipe section and the anomalous flow passage moment;
controlling, by an emergency supervision object platform, a robot to perform sonar detection on the target detection area at the target detection time, and acquiring sonar detection data, wherein the robot is equipped with a sonar sensor;
generating an estimated sedimentation thickness and a sedimentation type of the target detection area based on the sonar detection data and pipe characteristics;
determining a sedimentation risk based on the estimated sedimentation thickness, the sedimentation type, and the pipe characteristics;
automatically generating a desilting path and desilting parameters based on the sedimentation risk;
controlling, by the emergency supervision object platform, automated desilting equipment to travel along the desilting path to a desilting operation point, and performing a desilting operation based on the desilting parameters.

11. The drainage network sedimentation management method according to claim 10, wherein sonar frequencies of a plurality of pipe sections are different, the method further comprises:
determining a sonar frequency of the pipe section based on a pipe material, the estimated sedimentation thickness, and the sedimentation type.

12. The drainage network sedimentation management method according to claim 10, comprising:
screening the anomalous pipe section by a preset filtering condition based on precipitation within a preset time period, a restaurant wastewater discharge upstream of the anomalous pipe section, and a construction wastewater discharge, wherein the preset time period is prior to the anomalous flow passage moment;
determining an anomalous flow cross-sectional area series based on the screened anomalous pipe section;
determining the target detection area based on the anomalous flow cross-sectional area series.

13. The drainage network sedimentation management method according to claim 12, comprising:
determining flow fluctuation information based on historical precipitation, a historical restaurant wastewater discharge, and a historical construction wastewater discharge;
determining, based on the flow fluctuation information, whether a pseudo-abnormal flow area exists in the anomalous flow cross-sectional area series;
in response to existence of the pseudo-abnormal flow area, removing the pseudo-abnormal flow area from the anomalous flow cross-sectional area series to generate an updated anomalous flow cross-sectional area series;
determining the target detection area based on the updated anomalous flow cross-sectional area series.

14. The drainage network sedimentation management method according to claim 12, comprising:
determining a detection density in a circumferential direction of pipe in the target detection area based on a variation amplitude of the anomalous flow cross-sectional area series relative to a normal flow cross-sectional area series;
controlling, by the emergency supervision object platform, the robot to perform detection on the target detection area based on the detection density, and acquiring the sonar detection data;
generating the estimated sedimentation thickness and the sedimentation type of the target detection area by processing sonar detection data of a plurality of circumferential measurement points in the target detection area and the pipe characteristics through a sedimentation model, wherein the sedimentation model is a machine learning model.

15. The drainage network sedimentation management method according to claim 14, comprising:
determining a desilting accuracy rate based on the estimated sedimentation thickness and the sedimentation type;
determining an associated pipe section corresponding to the target detection area based on the desilting accuracy rate;
controlling, by the emergency supervision object platform, the robot to perform detection on the associated pipe section.

16. The drainage network sedimentation management method according to claim 10, comprising:
controlling, by the emergency supervision object platform, the robot to acquire desilting data of an actual desilting process;
adjusting the desilting parameters based on the desilting data;
controlling, by the emergency supervision object platform, the automated desilting equipment to perform the desilting operation based on the adjusted desilting parameters.

17. The drainage network sedimentation management method according to claim 16, comprising:
acquiring pipe image data of the pipe section by an image acquisition device;
determining an estimated sedimentation rate of a pipe in the pipe section based on the pipe image data;
performing the desilting operation on the pipe in the pipe section based on the estimated sedimentation rate.

18. The drainage network sedimentation management method according to claim 17, comprising:
determining, based on the estimated sedimentation rate, whether a candidate pipe section located on a pending desilting path in the pipe section satisfies a preset condition;
in response to the candidate pipe section satisfying the preset condition, determining the candidate pipe section as an additional operation point;
controlling, by the emergency supervision object platform, the automated desilting equipment to travel along the desilting path to the additional operation point to perform the desilting operation.

19. A computer-readable storage medium storing computer instructions, wherein when a computer reads the computer instructions in the storage medium, the computer executes a method for a drainage network sedimentation management based on a large Internet of Things (IoT) model, comprising:
acquiring flow data of a pipe section by an acquisition device deployed in a drainage network, and obtaining the flow data uploaded by the acquisition device;
determining a flow cross-sectional area series of a plurality of adjacent pipe sections based on the flow data of the pipe section;
determining an anomalous pipe section and an anomalous flow passage moment based on the flow cross-sectional area series of the plurality of adjacent pipe sections;
determining a target detection area and a target detection time based on the anomalous pipe section and the anomalous flow passage moment;
controlling, by an emergency supervision object platform, a robot to perform sonar detection on the target detection area at the target detection time, and acquiring sonar detection data, wherein the robot is equipped with a sonar sensor;
generating an estimated sedimentation thickness and a sedimentation type of the target detection area based on the sonar detection data and pipe characteristics;
determining a sedimentation risk based on the estimated sedimentation thickness, the sedimentation type, and the pipe characteristics;
automatically generating a desilting path and desilting parameters based on the sedimentation risk;
controlling, by the emergency supervision object platform, automated desilting equipment to travel along the desilting path to a desilting operation point, and performing a desilting operation based on the desilting parameters.
